(19) United States
(12) Patent Application Publication
(10) Pub. No.: US 2005/0171810 A1
(43) Pub. Date: Aug. 4, 2005

(54) System and method for monitoring business activities

(75) Inventors: Moshe Klein, Woodland Hills, CA (US); Alon Shwartz, Woodland Hills, CA (US); Jim Zafrani, Woodland Hills, CA (US)

Correspondence Address: MARVIN H. KLEINBERG;KLEINBERG & LERNER, LLP, Suite 1080, 2049 Century Park East, Los Angeles, CA, 90067, US

(73) Assignee: Synthean, Inc.

(21) Appl. No.: 11/047,054

(22) Filed: Jan. 31, 2005

Related U.S. Application Data
(63) Continuation-in-part of application No. 10/898,464, filed on Jul. 23, 2004.
(60) Provisional application No. 60/540,960, filed on Jan. 30, 2004.
(60) Provisional application No. 60/540,961, filed on Jan. 30, 2004.
(60) Provisional application No. 60/540,964, filed on Jan. 30, 2004.
(60) Provisional application No. 60/540,959, filed on Jan. 30, 2004.
(60) Provisional application No. 60/540,962, filed on Jan. 30, 2004.

(51) Int. Cl. G06F 17/60

(52) U.S. Cl. 705/1; 705/9; 705/11

(57) ABSTRACT

A method of monitoring business activities using a computer including the capture of event data for those business activities, correlation of that captured event data to a particular transaction, storage of that transaction data and calculating and providing metrics based upon event and transaction data.

This application claims priority as a continuation in part of the provisional patent applications: Checkpoint Processing Engine, Ser. No. 60/540,959 filed Jan. 30, 2004; Event Capture Engine, Ser. No. 60/540,961 filed Jan. 30, 2004; Information Provider Engine, Ser. No. 60/540,960 filed Jan. 30, 2004; Business Activity Architect, Ser. No. 60/540,964 filed Jan. 30, 2004; Transaction Processing Engine, Ser. No. 60/540,962 filed Jan. 30, 2004 and the non-provisional patent application Universal Transaction Identifier Ser. No. 10/898,464 filed Jul. 23, 2004.

### BACKGROUND

1. Field of the Invention

The present invention relates to business processes, and more specifically to a system and method for monitoring business activities.

2. Background of the Invention

Businesses operate via business activities, which are complex composites of sub- or micro-processes logically connected in the context of a common objective. For example, for a user of an internet website who is ordering a product, several different and distinct processes take place that all relate to the single transaction of purchasing the product. A web server delivers web pages with the requested content to the user. A database server provides some of the content. A credit card verification server ensures that payment is validated. A shipping server might take care of automating the shipping process. Finally, an inventory server could decrement the inventory list for the item demonstrating that one has been purchased. Any number of other servers and networked interactions can take place in effecting a single transaction.

In the prior art, the tracking of a single instance of a business activity has been relatively difficult. Capturing the data associated with each step in an instance of a business activity has been even more difficult. In prior art solutions, a single unique transaction identifier has been required to be passed from each server to server or process to process along the way to the completion of the entire instance of the business activity. Alternatively, an event within an instance of a business activity would be evaluated by going to the server or process that failed and receiving a single report from that server or process. For example, if a credit card server failed to properly process a charge to a customer, the only report of what occurred would exist in the records of the credit card server itself. This problem is only exacerbated when multiple instances of business activities fail at a particular server or process or several servers or processes and the business needs timely information in order to address these issues efficiently and effectively.

It is therefore an object of the present invention to provide a means by which business activities may be monitored effectively. It is another objective of the present invention to make the business activity monitoring process more simple and more accessible. It is a further objective of the present invention to aggregate event data, grouping it by instance of a business activity and to perform computations as to the efficiency and accuracy of those business activities. These and other objectives of the present invention will become apparent from the following description of the invention.

### SUMMARY OF THE INVENTION

A system and method for monitoring business activities is described. This system may be used to monitor complex information technology infrastructures and to provide access to information concerning the business activities taking place in that information technology infrastructure.

### BRIEF DESCRIPTION OF THE DRAWINGS

FIG. 1 is a block diagram showing the elements of a computer system which can be used to implement the present invention.

FIG. 2 illustrates the elements of a sample IT infrastructure that may be used by a business enterprise.

FIG. 3 illustrates the various systems used in a representative business activity using the sample IT infrastructure.

FIG. 4 is a series of checkpoints in an example business activity using the elements in FIG. 3.

FIG. 5 is an example of the elements that may be included in a transaction that may be in each event monitored by this process.

FIG. 6 is a depiction of the information technology infrastructure from FIG. 3 along with example event data that may be included in each element.

FIG. 7 is a flow-chart depicting the process of monitoring a business activity.

### DETAILED DESCRIPTION OF THE INVENTION

The present invention provides a system and method, implemented on a computer system, for monitoring business activities. The system and method described may be used to model a business activity, collect event data from each event in an instance of a business activity, to organize each event and the associated event data and to perform corrective actions. Other capabilities of this invention will become evident from the following disclosure. In most instances, specific details are included in order to further clarify the invention. However, in other instances, well known elements such as the computer's operating system and specific software functions are not described in detail so as not to obscure the present invention unnecessarily.

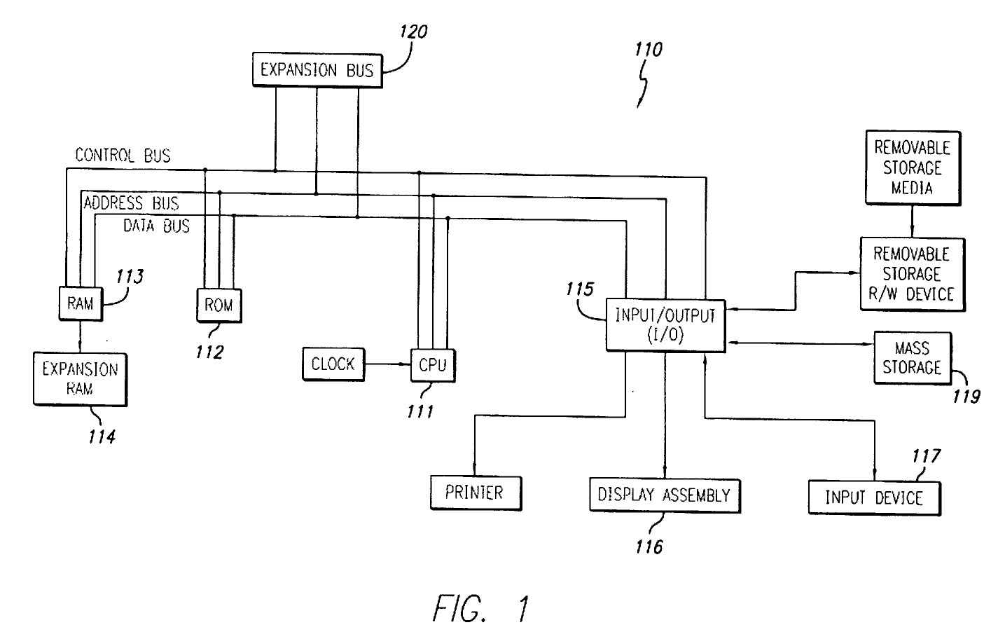

Referring first to FIG. 1, a block diagram of a general purpose computer system which may be used to implement the method of the present invention is illustrated. Specifically, FIG. 1 shows a general purpose computer system 110 for use in practicing the present invention. As shown in FIG. 1, computer system 110 includes a central processing unit (CPU) 111, read-only memory (ROM) 112, random access memory (RAM) 113, expansion RAM 114, input/output (I/O) circuitry 115, display assembly 116, input device 117, and expansion bus 120. The computer system 110 may also optionally include a mass storage unit 119 such as a disk drive unit or nonvolatile memory such as flash memory and a real-time clock 121.

Some type of mass storage 119 generally is considered desirable. However, mass storage 119 can be eliminated by providing a sufficient mount of RAM 113 and expansion RAM 114 to store user application programs and data. In that case, RAMs 113 and 114 can optionally be provided with a backup battery to prevent the loss of data even when computer system 110 is turned off. However, it is generally desirable to have some type of long term mass storage 119 such as a commercially available hard disk drive, nonvolatile memory such as flash memory, battery backed RAM, PC-data cards, or the like. The controlled vocabulary data which is stored in the present invention will be generally stored on mass storage device 119.

In operation, information is input into the computer system 110 by typing on a keyboard, manipulating a mouse or trackball, or “writing” on a tablet or on a position-sensing screen of display assembly 116. CPU 111 then processes the data under control of an operating system and an application program, such as a program to perform steps of the inventive method described above, stored in ROM 112 and/or RAM 113. CPU 111 then typically produces data which is output to the display assembly 116 to produce appropriate images on its screen.

Suitable computers for use in implementing the present invention are well known in the art and may be obtained from various vendors. The preferred embodiment of the present invention is intended to be implemented on a personal computer system, web server or other business application server. Various other types of computers, however, may be used depending upon the size and complexity of the required tasks. Suitable computers include mainframe computers, multiprocessor computers and workstations.

The present invention can be utilized to enable a business enterprise to examine business activities in a more efficient and cost-effective manner. The term “business activity” as used herein refers to a logically related series of processes or functions that are performed by the business enterprise in combination to achieve a desired goal. For example, a business activity can be as simple as taking an order from a customer, and delivering a product in response. On the other hand a business activity can be as complex as all of the functions performed by a network of servers performing various functions in the completion of an online order for a product.

An “instance” of a business activity is all of the operations performed in completing one instance of the business activity. For example, as described above the business activity could be taking an order online and delivering a product. An instance of that business activity could be one individual's order for a specific product processed from start to finish including all of the processes in between. A business activity is the general case, whereas an instance of a business activity is the specific case. The business activity includes all of the processes necessary to complete one business activity in the general, whereas an instance of a business activity is each of those processes performed in one specific instance. In the case of the financial advisor example, the business activity would be advising the client and all of the functions and processes necessary to reach that objective. The instance of the business activity would be advising a specific client, using those functions and processes toward the goal of advising a specific client. Another instance of that business activity would be the advising of a different client, and so on. Alternatively, an instance of a business activity may also be called a transaction. One transaction could be the purchase of the product online, whereas the business activity would be the general definition of the processes and functions necessary to purchase a product online.

A “checkpoint” or “event” is a single step in the completion of an instance of a business activity. An example of a checkpoint could be the step in the purchase of a product over the internet, where the IT infrastructure of the business attempts to charge the specified amount to the customer. The attempt to charge the card would be a checkpoint. A successful charge made to the card would be another checkpoint. A timeout, no response from the credit card server for a specified period of time, would be a failed checkpoint. A typical timeout for a charge to a user's credit card could be as short as thirty seconds or as long as five minutes, depending upon the implementation.

Checkpoints are defined business activity-wide. So, for example, the process of charging the card, start to finish, would be one complete checkpoint definition. Each checkpoint is a single step in the process, but checkpoint definitions do not have meaning outside of other checkpoints, such as the request for the credit card charge only has meaning as a completed checkpoint once the successful charge is made or the credit card is declined or there is a timeout of the operation. At that point, the checkpoint has meaning in relation to other checkpoints in the process. This means that for each business activity there are several related checkpoint definitions. For the process of completing an order using the Internet, example checkpoints could be web server access request, web server access response, requesting a product be put into an online shopping cart, putting a product into an online shopping cart, attempting to charge the credit card for a specified amount, receiving a response to that credit card charge request, passing the request to ship along to a shipping department and actually shipping the product. Many other checkpoints in that business activity could also be included. Checkpoints are only completed (successful) or not-completed (failed) in instances of a business activity. A business activity is the abstract “definition” of each instance of a business activity. Thus in the abstract placing an order online, a checkpoint is only completed or not completed in the actual placing of a specific order.

“Event data” or “data” as used herein refers to data used or processed in the process of completing or attempting to complete a checkpoint. This data could be an individual's name, address and credit card number. This data could also be an internet protocol address for a user's computer or the server itself. Any data that the user of the checkpoint processing engine desires to log may be included in the “event data” that is created.

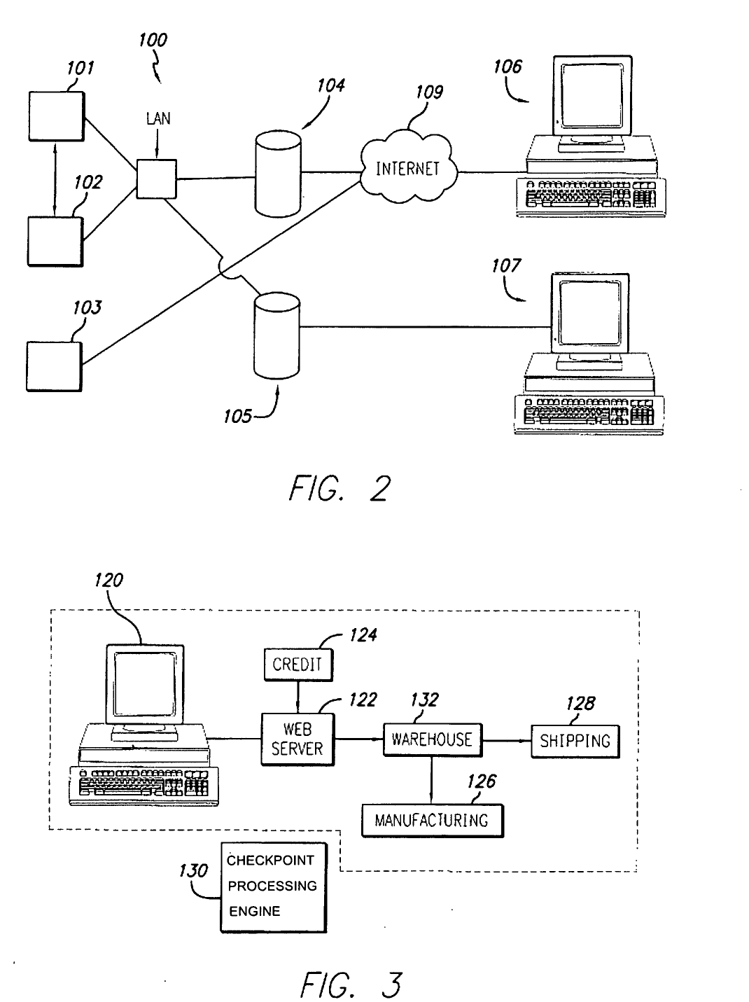

Many modern business activities are executed using a complex series of computers which make up an IT infrastructure. Referring next to FIG. 2, a representation of an example IT infrastructure 100 used by a business to complete a business activity is illustrated. The infrastructure may include a number of computer servers 101, 102, 103 which execute various functions or steps in a business activity. Although only three computer servers are illustrated in FIG. 2, it will be understood that a larger number of servers may be present in the infrastructure as required by the complexity of the business activity. The infrastructure may also include one or more databases 104, 105 for the storage and retrieval of data. Also Internet web servers 106, 107 may also be employed. Various other servers may also be included within an IT infrastructure.

Referring next to FIG. 3 a representative business activity is shown, including the elements on which that business activity is performed. The elements used in this example information technology infrastructure are a personal computer 120, a credit card processing server 124, a web server 122, a warehouse processing server 132, a shipping server 128, and a manufacturing server 126. The manufacturing server will likely be outside of, for example, any retailer's infrastructure, but communication will likely, take place between the company's infrastructure and the outside manufacturer's.

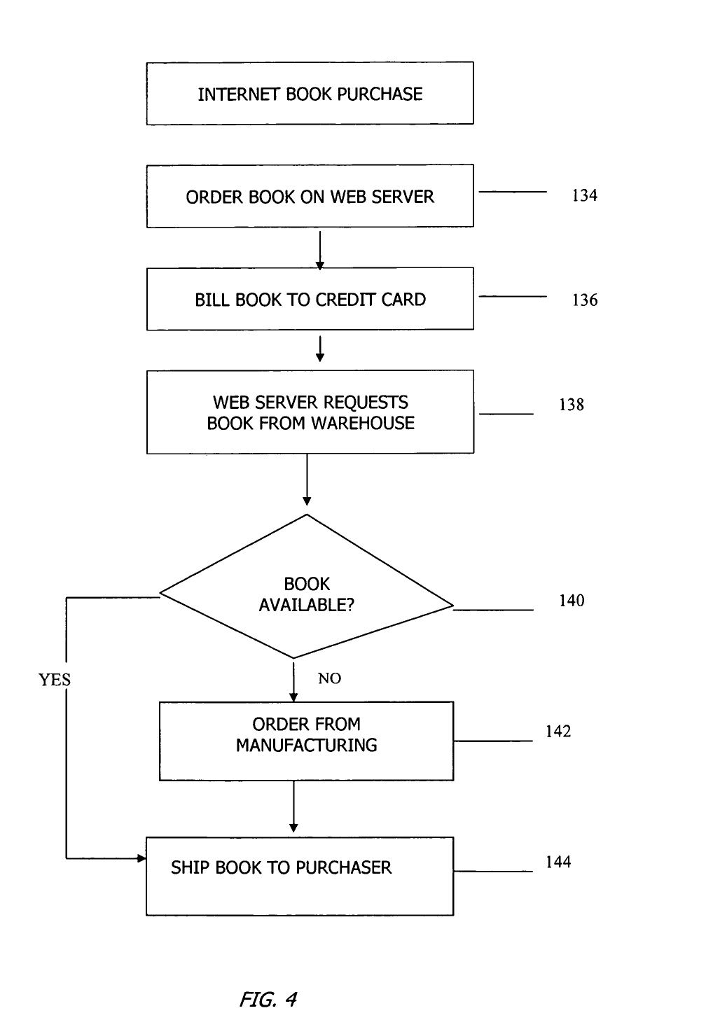

Referring to FIGS. 3 and 4, an example transaction is depicted. In this transaction, the user may place an order for a book 134 using her home computer 120 and using the web server 122. This order would include various data about the transaction including the user's name, address, credit card number, quality of product desired and any number of other data. Because this order is placed for this book using a credit card, the credit server 124 processes that card and bill the user's account 136. The web server 122, then passes data on to the warehouse processing server 132 in step 138, such as the item number, the person's name and address ordering the product. The warehouse server 132 determines if any of that book are available 140 and, if not, contacts the server of the publisher or manufacturer 126 of the book to place an order 142. Once the book is available, the warehouse server 132, then contacts its shipping server 128, sending name and address along for mailing purposes which ships the book to the purchaser 144.

Along the way, each step of this transaction passes data in various forms back and forth across a network. This is a very simple example. In any large-scale online retailing infrastructure, there are multiple web servers, accounting servers, database servers, order processing servers, data storage servers, and the like. Many times, entire clusters or clusters of clusters of servers are used to perform various functions in the online process. In industries other than online retailing, the servers may simply be web servers, file transfer protocol servers, virtual private network gateway servers, and internet portal servers that also pass similar data back and forth.

These examples make it easier to demonstrate that during this process, data is constantly being passed back and forth between the servers. This data is very rarely and almost never in the same or similar format. More recently efforts have been made to use a standard interface format between machines to aid in usability across different software platforms, but in many instances this is not available or simply impossible given the type of tasks being performed. One example of such an effort is the increasing use of extended markup language.

Referring again to FIG. 3, the business activity monitor 130 server or servers run on an additional server. This server or group of servers is responsible for the entire process of business monitoring. Portions of this server are included in the co-pending patent applications entitled Checkpoint Processing Engine with Ser. No. 60/540,959 filed Jan. 30, 2004, Event Capture Engine with Ser. No. 60/540,961, filed Jan. 30, 2004 and Transaction Processing Engine with Ser. No. 60/540,962 filed Jan. 30, 2004. Each of these portions of this application may be run on a different server or may be run on a single server responsible for monitoring business activities. These portions of the business activity monitor may be run on groups of servers as well. Each of these portions is responsible for a part of the complete process of monitoring a business activity.

Referring again to the prior example, as the book is purchased, data is sent from the purchaser's home computer to the web server over the Internet. Using the adaptor designed to listen for a web page request event, even for one for a particular web page or type of web page, the Event Capture Engine extracts the data from the event. This process is described in the co-pending patent application Ser. No. 60/540,964 filed Jan. 30, 2004. This captured event data is processed by the co-pending patent application entitled Checkpoint Processing Engine with Ser. No. 60/540,959. Once the checkpoint data has been processed and formatted appropriately, the Transaction Processing Engine described in the co-pending patent application Ser. No. 60/540,962 filed Jan. 30, 2004 receives the data and begins correlating that event with a particular instance of a business activity or transaction. Next the data is stored for late review by a user or to be evaluated using various mathematical models and algorithms for efficiency and other measures.

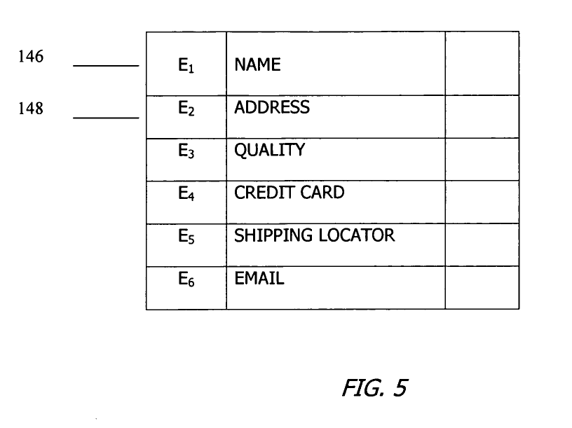

Referring next to FIG. 5, an example of the data that may be passed back and forth among various elements of the information technology infrastructure during a complete instance of a business activity is depicted. Depicted in element 146 is name. In element 148 is address. During each event, however, all of the data will almost certainly never be sent at once or in an easily identifiable format. As this data is captured by the Event Capture Engine, it is saved and then passed along to the Checkpoint Processing Engine. The Event Capture Engine does not “know” the entirety of the transaction data as depicted here, it only knows that it must capture, for example, name 146 and address 148 in this particular event and save them for later use. The Transaction Processing Engine then groups these pieces of data that are found in each step of the instance of a business activity into one single instance.

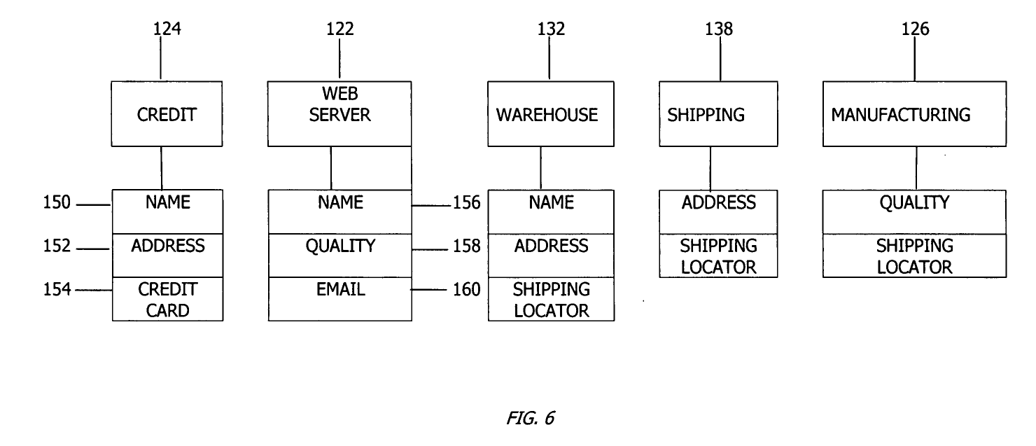

Referring now to FIG. 6, each of the information technology infrastructure elements depicted in FIG. 3 are included, along with the pieces of information each element gives or receives during a communication. For example, the credit card processing server 124 gives and receives the name 150, the address 152 and the credit card number 154. In this example, the credit card processing server 124 receives or transmits no other data elements. The web server 122, receives or transmits the name 156, a quality requirement of the product 158 and the email 160 of the purchaser. Therefore, no single portion of the infrastructure has access to a complete listing of data elements, as depicted in FIG. 5.

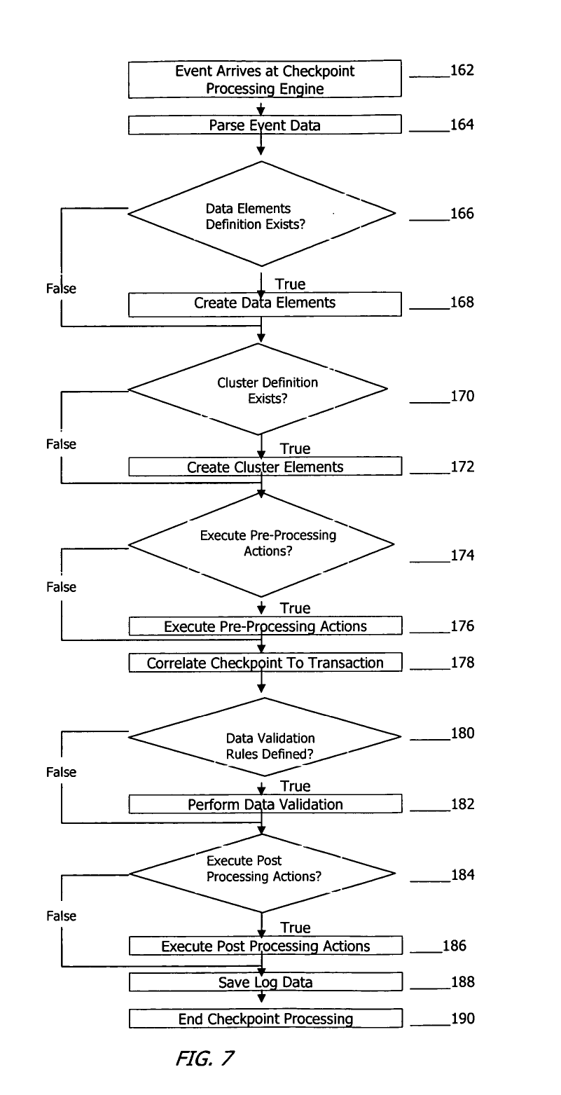

Referring now to FIG. 7, a flowchart depicting the preferred embodiment of the process of automatic business modeling is depicted. The first element in the process is the enterprise application 162. The enterprise application 162 may be a web server application running on a particular computer or it may be a portion of accounting software running on an office computer. These applications are the basis for each business activity. Business activities take place on at least one enterprise application, usually more than one. This application is “listened to” by the monitoring agent 164. This is also described as an adaptor in the co-pending application entitled Event Capture Engine Ser. No. 60/540,961 filed Jan. 30, 2004. This monitoring agent uses several means to “listen” to the enterprise application 162. In the preferred embodiment, two means are described, a non-intrusive and an intrusive means. Utilizing these two means, the Event Capture Engine 168 captures the data being used by the enterprise application 162 as each checkpoint takes place. This data is captured when an event checkpoint 166 occurs.

This data is then formatted and stored by the Event Capture Engine 168, to be passed along to the Checkpoint Processing Engine 172 in the form of checkpoint data 170. The data for example, could include the person's name and address, for data captured from the shipping server. This data, when collected later along with data generated from other portions of this instance of a business activity will be collected and organized to provide a complete picture of the instance of a business activity and any problems that occurred during this instance of a business activity. The checkpoint data once it has been captured by the Event Capture Engine is organized and filtered data from the checkpoint itself. Primarily data relevant to the user and monitor of this business activity is captured, using the adaptors or monitoring agents 164.

The Checkpoint Processing Engine 172 receives the processed checkpoint data 170 and further processes the data contained therein. It determines the type of data that has been captured, attempts to categorize it based upon the type. If not possible, it categorizes the data based on the type of server or servers it came from for later review and categorization as a part of a business activity. The data is then stored for use by the Transaction Processing Engine 176. It is passed along as transaction data 174 to be correlated to a particular transaction or business activity. The Transaction Processing Engine is responsible for taking the now organized data from each individual event in a given instance of a business activity and then organizing that data, based upon the elements contained in that data and using the Universal Transaction Identifier Ser. No. 10/898,464 filed Jul. 23, 2004, into complete transactions, containing each checkpoint along the way to completion of an instance of a business activity. These completed transactions now contain each of the data elements as depicted in FIG. 5, though no single event along the way contained all of those elements. Once the transactions have been processed, various metrics of the efficiency of transactions and checkpoints may be calculated, either from the aggregated transaction data or aggregated single-checkpoint data. These metrics are described in detail in the Transaction Processing Engine co-pending application.

Once this process is completed, all of the transaction data 178 from each checkpoint and the completed transaction, including any metric data, is stored to the data repository 184. This data may then be used in at least two ways in the preferred embodiment of the invention. The first way is useful when no definition of the business activities exist. If the business activity monitor is run without any prior understanding of the process being monitored, it will do its best to correlate and store checkpoint and transaction data. This data may then be used to create a business activity model 180. This may be done, in the preferred embodiment, either by manually using the business activity modeler 182 or by allowing the business activity modeler 182 to utilize the newly acquired data to “guess” at the likely business activity or business activities being monitored in this information technology infrastructure. The alternative use of the data is to gather and use information pertaining to the events, instances of business activities and overall business activities. The transaction data 186, especially when aggregated in the data repository 184 may be seen by the user through the use of the information provider 188. The information provider 188 is an interface designed to read the data in the data repository 184 and then organize this data based upon user requests. A user may request to see all transactions in the last hour, day, week or year. The user may request to see all transactions within a certain time frame. A user may request to see all of the results and data pertaining to an individual type of event. This would be useful, for example, if one event was failing far more than was expected. This request, using the information provider 188 would be sent as a data request 190 from a management console 192. The management console may be a particular computer with software especially designed to interface to the information provider. Alternatively, it may simply be any computer with web access, using a web portal to access the information provider 188 through the portal.

Once the process is completed, for a particular transaction. All of the data pertaining to that transaction will be logged, including each data element included along the way with a unique transaction identifier assigned to each transaction as it is processed. This data will be present in one location, be detailed such that the user may make adjustments to the ways in which data is processed and to the servers if any issues appear.

Accordingly, a system and method of business activity monitoring has been described. It is to be understood that the foregoing description has been made with respect to specific embodiments thereof for illustrative purposes only. The overall spirit and scope of the present invention is limited only by the following claims, as defined in the foregoing description.

1. A method of monitoring a business activity comprising the steps of:
determining when at least one event has occurred in said business activity;
monitoring the event data used in said at least one event;
collecting said event data;
correlating said event data to the transaction of which it is a part to thereby create transaction data; and
storing said event data as a part of said transaction.

2. A digital computer system programmed to perform the steps specified in the method of claim 1.

3. Computer-readable media containing programming designed to accomplish the method of claim 1.

4. The method of claim 1, wherein said correlating step is performed using a unique transaction identifier.

5. The method of claim 1, further comprising the additional step of calculating metrics based upon said event data.

6. The method of claim 1, wherein said collecting step takes place using at least one adapter.

7. The method of claim 1, further comprising the additional step of providing said event data to a user.

8. The method of claim 1, further comprising the additional step of providing said transaction data to a user.

9. The method of claim 8, further comprising the additional step of calculating metrics based upon said transaction data.

10. A method of monitoring a business activity comprising the steps of:
determining when at least one event has occurred in said business activity;
monitoring the event data used in said at least one event;
collecting said event data;
correlating said event data to the transaction of which it is a part to thereby create transaction data;
storing said event data as a part of said transaction; and
providing metrics based upon said event data and said transaction data.

11. A digital computer system programmed to perform the steps specified in the method of claim 10.

12. Computer-readable media containing programming designed to accomplish the method of claim 10.

13. A computer-based apparatus for monitoring a business activity comprising:
event monitoring means for monitoring events in said business activity;
collection means connected to said event monitoring means for collecting data from said events;
correlation means connected to said collection means for correlating said data with a particular transaction;
storage means connected to said correlation means for storing said event data correlated transaction data;
output means connected to said storage means for providing output of data and metrics based upon said transaction data.
